(19) United States
(12) Patent Application Publication
(10) Pub. No.: US 2024/0289387 A1
(43) Pub. Date: Aug. 29, 2024

(54) GRAPH DATABASE PROCESSING

(71) Applicant: Alipay (Hangzhou) Information Technology Co., Ltd., Zhejinag (CN)

(72) Inventor: Boyao ZHU, Hangzhou (CN)

(21) Appl. No.: 18/572,325

(22) PCT Filed: Oct. 18, 2022
(86) PCT No.: PCT/CN2022/125821

§ 371 Date: Dec. 20, 2023

(30) Foreign Application Priority Data
Oct. 21, 2021 (CN) 202111224569.2

(51) Int. Cl. G06F 16/901; G06F 16/906

(52) U.S. Cl. CPC G06F 16/9024; G06F 16/906

(57) ABSTRACT

Embodiments of this specification provide a graph database processing method and apparatus. In the graph database processing method, a current system time point of a graph database system is obtained. A timestamp of each piece of edge data is obtained from a graph database. Expired edge data is determined from all the pieces of edge data based on the current system time point, the timestamp of each piece of edge data, and a survival time period of each piece of edge data. The determined expired edge data is deleted from the graph database in response to that the expired edge data is determined.

### TECHNICAL FIELD

Embodiments of this specification usually relate to the database field, and in particular, to a graph database processing method and apparatus.

### BACKGROUND

Graph data is stored in a graph data storage device or a memory of a graph data processing device in a form of a graph database. Edge data in the graph database is usually time-sensitive. As time passes, some edge data in the graph database expires and no longer functions, so that expired edge data needs to be determined from the graph database and the expired edge data is cleared from the graph database.

### SUMMARY

In view of the above-mentioned descriptions, embodiments of this specification provide a graph database processing method and apparatus. According to the graph database processing method and apparatus, expired edge data can be efficiently determined from a graph database.

According to an aspect of the embodiments of this specification, a graph database processing method is provided, including: obtaining a current system time point of a graph database system; obtaining a timestamp of each piece of edge data from a graph database; and determining expired edge data from all the pieces of edge data based on the current system time point, the timestamp of each piece of edge data, and a survival time period of each piece of edge data.

Optionally, in an example of the aspect, the graph database processing method can further include: deleting the determined expired edge data from the graph database in response to that the expired edge data is determined.

Optionally, in an example of the aspect, an edge identifier of the edge data includes a timestamp, and the obtaining a timestamp of each piece of edge data from a graph database can include: obtaining each piece of edge data from the graph database; extracting the edge identifier from each piece of obtained edge data; parsing the edge identifier of each piece of edge data; and extracting the timestamp of each piece of edge data from the parsed edge identifier of each piece of edge data.

Optionally, in an example of the aspect, an edge attribute of the edge data includes a timestamp attribute, and the obtaining a timestamp of each piece of edge data from a graph database can include: obtaining each piece of edge data from the graph database; extracting the edge attribute from each piece of obtained edge data; parsing the extracted edge attribute of each piece of edge data; and extracting the timestamp of each piece of edge data from the parsed edge attribute of each piece of edge data.

Optionally, in an example of the aspect, the survival time period of each piece of edge data includes a survival time period of each piece of edge data entered by a user.

Optionally, in an example of the aspect, an edge identifier of the edge data includes an edge type, and the graph database processing method can further include: extracting the edge type of each piece of edge data from a parsed edge identifier of each piece of edge data; and obtaining the survival time period of each piece of edge data from a system configuration file of the graph database system based on the edge type of each piece of edge data.

According to another aspect of the embodiments of this specification, a graph database processing method is provided. An edge identifier of edge data in a graph database includes a start point ID, an edge type, a timestamp, and an endpoint ID, the edge data is sorted based on the start point ID, the edge type, the timestamp, and the endpoint ID, and then sequentially stored in the graph database, and the graph database processing method includes: obtaining a current system time point of a graph database system; classifying the edge data in the graph database based on the start point ID and the edge type in the edge identifier; and for each type of edge data, determining the first piece of expired edge data in the type of edge data based on the current system time point and a survival time period corresponding to the edge type, and determining that all edge data whose timestamp is ranked after that of the first piece of expired edge data in the type of edge data is expired edge data.

Optionally, in an example of the aspect, a classification process of the edge data and/or a determining process of the first piece of expired edge data are implemented based on a dichotomy.

According to another aspect of the embodiments of this specification, a graph database processing apparatus is provided, including: a system time point obtaining unit, configured to obtain a current system time point of a graph database system; a timestamp obtaining unit, configured to obtain a timestamp of each piece of edge data from a graph database; and an expired data determining unit, configured to determine expired edge data from all the pieces of edge data based on the current system time point, the timestamp of each piece of edge data, and a survival time period of each piece of edge data.

Optionally, in an example of the aspect, the graph database processing apparatus can further include: an expired data deletion unit, configured to delete the determined expired edge data from the graph database in response to that the expired edge data is determined.

Optionally, in an example of the aspect, an edge identifier of the edge data includes a timestamp, and correspondingly, the timestamp obtaining unit can include: an edge data obtaining module, configured to obtain each piece of edge data from the graph database; an edge identifier extraction module, configured to extract the edge identifier from each piece of obtained edge data; an edge identifier parsing module, configured to parse the edge identifier of each piece of edge data; and a timestamp extraction module, configured to extract the timestamp of each piece of edge data from the parsed edge identifier of each piece of edge data.

Optionally, in an example of the aspect, an edge attribute of the edge data includes a timestamp attribute, and correspondingly, the timestamp obtaining unit can include: an edge data obtaining module, configured to obtain each piece of edge data from the graph database; an edge attribute extraction module, configured to extract the edge attribute from each piece of obtained edge data; an edge attribute parsing module, configured to parse the extracted edge attribute of each piece of edge data; and a timestamp extraction module, configured to extract the timestamp of each piece of edge data from the parsed edge attribute of each piece of edge data.

Optionally, in an example of the aspect, the graph database processing apparatus can further include: a survival time period obtaining unit, configured to obtain a survival time period of each piece of edge data entered by a user.

Optionally, in an example of the aspect, an edge identifier of the edge data includes an edge type, and correspondingly, the graph database processing apparatus can further include: an edge type extraction unit, configured to extract the edge type of each piece of edge data from a parsed edge identifier of each piece of edge data; and a survival time period obtaining unit, configured to obtain the survival time period of each piece of edge data from a system configuration file of the graph database system based on the edge type of each piece of edge data.

According to another aspect of the embodiments of this specification, a graph database processing apparatus is provided. An edge identifier of edge data in a graph database includes a start point ID, an edge type, a timestamp, and an endpoint ID, the edge data is sorted based on the start point ID, the edge type, the timestamp, and the endpoint ID, and then sequentially stored in the graph database, and the graph database processing apparatus includes: a system time point obtaining unit, configured to obtain a current system time point of a graph database system; an edge data classification unit, configured to classify the edge data in the graph database based on the start identifier and the edge type in the edge identifier; and an expired data determining unit, configured to: for each type of edge data, determine the first piece of expired edge data in the type of edge data based on the current system time point and a survival time period corresponding to the edge type, and determine that all edge data whose timestamp is ranked after that of the first piece of expired edge data in the type of edge data is expired edge data.

According to another aspect of the embodiments of this specification, a graph database processing apparatus is provided, and includes at least one processor, a storage coupled to the at least one processor, and a computer program stored in the storage. The at least one processor executes the computer program to implement the graph database processing method.

According to another aspect of the embodiments of this specification, a computer-readable storage medium is provided. The computer-readable storage medium stores executable instructions. When the instructions are executed, a processor is enabled to perform the graph database processing method.

According to another aspect of the embodiments of this specification, a computer program product is provided, and includes a computer program. The computer program is executed by a processor to implement the graph database processing method.

### BRIEF DESCRIPTION OF DRAWINGS

The essence and advantages of the content of this specification can be further understood with reference to the following accompanying drawings. In the accompanying drawings, similar components or features can have the same reference numerals.

FIG. 1 is an example schematic diagram illustrating a data structure of graph data stored in a graph database, according to an embodiment of this specification;

FIG. 2 is an example flowchart illustrating a graph database processing method, according to an embodiment of this specification;

FIG. 3 is an example flowchart illustrating a timestamp obtaining process, according to an embodiment of this specification;

FIG. 4 is another example flowchart illustrating a timestamp obtaining process, according to an embodiment of this specification;

FIG. 5 is an example flowchart illustrating a survival time period obtaining process, according to an embodiment of this specification;

FIG. 6 is another example flowchart illustrating a graph database processing method, according to an embodiment of this specification;

FIG. 7 is an example block diagram illustrating a graph database processing apparatus, according to an embodiment of this specification;

FIG. 8 is an example block diagram illustrating a timestamp obtaining unit, according to an embodiment of this specification;

FIG. 9 is another example block diagram illustrating a timestamp obtaining unit, according to an embodiment of this specification;

FIG. 10 is another example block diagram illustrating a graph database processing apparatus, according to an embodiment of this specification; and

FIG. 11 is an example schematic diagram illustrating a graph database processing apparatus implemented based on a computer system, according to an embodiment of this specification.

### DESCRIPTION OF EMBODIMENTS

The subject matter described in this specification is discussed now with reference to example implementations. It should be understood that these implementations are described only to enable a person skilled in the art to better understand and implement the subject matter described in this specification, and are not intended to limit the protection scope, applicability, or examples described in the claims. The functions and arrangements of the elements under discussion can be changed without departing from the protection scope of the content of this specification. Various processes or components can be omitted, replaced, or added in the examples based on needs. For example, the described method can be performed in a sequence different from the described sequence, and steps can be added, omitted, or combined. In addition, features described relative to some examples can be combined in other examples.

As used in this specification, the term “including” and variants thereof represent open terms, and mean “including but not limited to”. The term “based on” means “at least partially based on”. The terms “one embodiment” and “an embodiment” mean “at least one embodiment”. The term “another embodiment” means “at least one other embodiment”. The terms “first”, “second” etc. can refer to different or the same objects. Other definitions can be included below, either explicitly or implicitly. Unless explicitly stated in the context, the definition of a term is consistent throughout this specification.

Graph data includes vertex data and edge data. The vertex data can include, for example, a vertex identifier and a vertex attribute, and the edge data can include a start point ID, an endpoint ID, and an edge attribute. The vertex identifier is used to uniquely identify a vertex. The vertex identifier, the vertex attribute, and the edge attribute can be related to a service. For example, in a social network scenario, the vertex identifier can be an identity card number of a person, a person number, etc. The vertex attribute can include an age, an education, an address, an occupation, etc. The edge attribute can include a relationship between vertexes, that is, a relationship between persons, for example, a classmate/colleague relationship.

The following describes a graph database processing method and a graph database processing apparatus according to the embodiments of this specification with reference to the accompanying drawings.

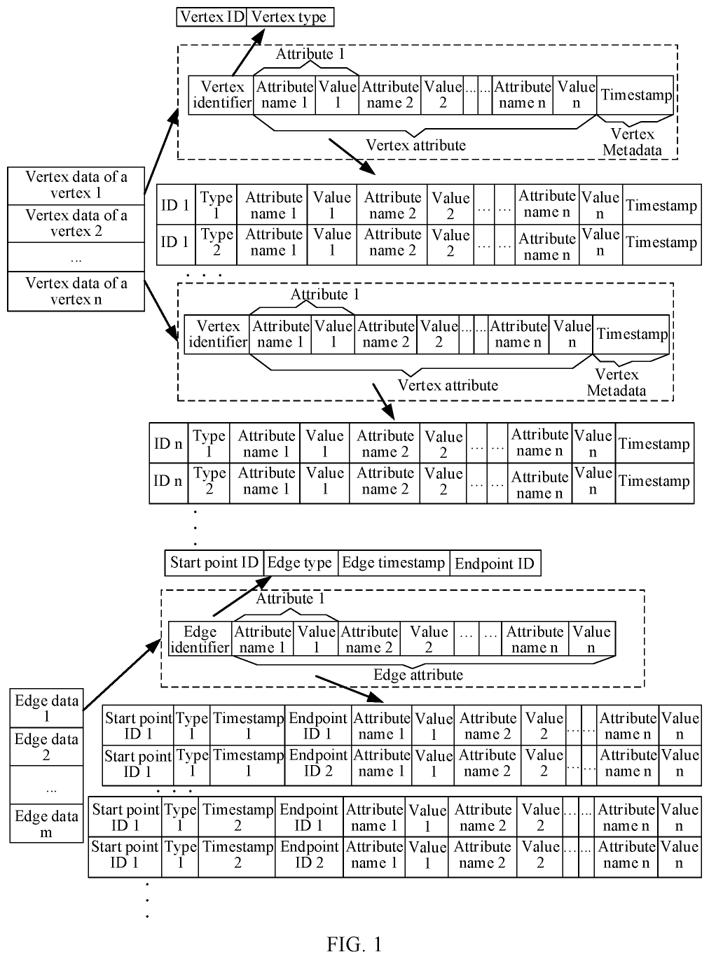

FIG. 1 is an example schematic diagram illustrating a data structure of graph data stored in a graph database, according to an embodiment of this specification.

As shown in FIG. 1, vertex data can include a vertex identifier and a vertex attribute. Correspondingly, a data storage structure of the vertex data can include a vertex identifier field and a vertex attribute field. The vertex identifier field is used to store a vertex identifier of a vertex. The vertex identifier can include a vertex ID and a vertex type. In another example, the vertex identifier can alternatively include only a vertex ID. The vertex attribute field is used to store a vertex attribute of a vertex. The vertex attribute can include one or more vertex attributes. Each vertex attribute can include an attribute name and an attribute value. The attribute name can include, for example, “age”, “height”, “occupation”, etc. The attribute value is a corresponding value of the attribute name. Optionally, the attribute name can be used to establish an index, to support condition filtering during a data query. In addition, the vertex data can further include vertex metadata. Correspondingly, the data storage structure of the vertex data can further include a vertex metadata field. The vertex metadata field is used to store vertex metadata of a vertex. The vertex metadata can include a query condition used for a data query, such as a vertex timestamp. Optionally, in an example, the vertex metadata can further include a vertex type. The vertex type can be, for example, feature information for implementing vertex classification, for example, “person”, “company”, or “device”. As shown in FIG. 1, the vertex data can be sorted based on vertex identifiers, and stored based on a sorting result.

Edge data can include an edge identifier and an edge attribute. Correspondingly, a storage structure of the edge data can include an edge identifier field and an edge attribute field. The edge identifier field is used to store an edge identifier. In an example, the edge identifier can include a start point ID (source vertex ID, SrcId), an edge type, an edge timestamp, and an endpoint ID (destination vertex ID, DesId). The edge type can be, for example, feature information for implementing edge classification. For example, when the egress edge indicates an account transfer, the edge type can be “transfer”. When the egress edge indicates payment, the edge type can be “payment”. In the above-mentioned manner, one piece of edge data in the graph database can be uniquely identified based on a start point ID, an endpoint ID, an edge timestamp, and an edge type. For example, assuming that there is transfer edge data of a transfer from A to B, “vertex identifier & transfer time point T& transfer edge of the start point A and the endpoint B” can be used as an edge identifier of the transfer edge data. Optionally, in another example, the edge identifier can possibly not include the edge type and/or the edge timestamp.

The edge attribute field can include one or more edge attribute fields. Each edge attribute field can include an attribute name field and an attribute value field. The attribute name field is used to store an attribute name of the edge attribute, and the attribute value field is used to store an attribute value of the edge attribute. The attribute name of the edge attribute can include, for example, “amount”, “currency”, “operating device”, or “timestamp”. The attribute value of the edge attribute is a corresponding value of the attribute name. For example, there is a friendly relationship edge between the vertex A and the vertex B, the friendly relationship edge can have a timestamp attribute, and the timestamp attribute represents a latest interaction time point of the vertex A and the vertex B.

Similarly, when the edge data is stored, the edge data needs to be sorted based on the edge identifier, and the edge data is stored based on a sorting result. As shown in FIG. 1, the stored edge data can include edge data 1 to edge data m. Edge data i stores all egress edge data of a start point i. In an example, when sorting is performed, sorting can be sequentially performed based on the start point ID, the edge type, the timestamp, and the endpoint ID. To be specific, sorting is performed based on the start point ID, and then sorting is performed based on the edge type in a sorting result of each start point ID. Then, sorting is performed based on a timestamp in a sorting result of each edge type. Finally, sorting is performed based on an endpoint ID in a sorting result of each timestamp, to obtain a final sorting result, and the edge data is stored in a graph database in a graph database system based on the final sorting result, as shown in FIG. 1. In addition, preferably, timestamp information is not stored in both the edge identifier and the edge attribute.

The foregoing describes an example of the stored data structure of the graph data in this embodiment of this specification with reference to FIG. 1. In another embodiment of this specification, the graph data can also be stored in another proper data storage manner.

As described above, the graph data is stored in the graph database. Because the edge data in the graph database is usually time-sensitive, as time passes, some edge data in the graph database expires and no longer functions. Therefore, expired edge data in the graph database needs to be processed periodically, so that expired edge data is determined from the graph database and the expired edge data is cleared from the graph database.

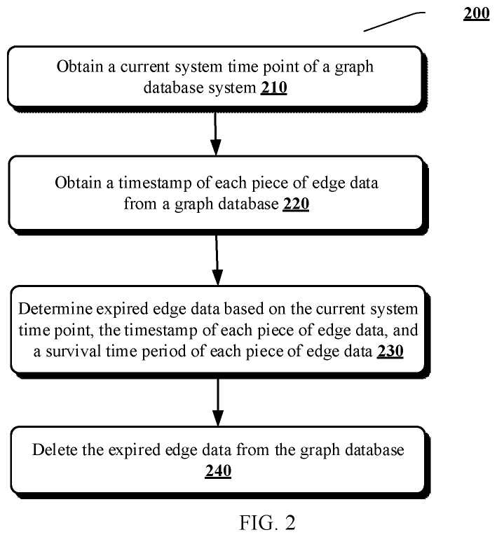

FIG. 2 is an example flowchart illustrating a graph database processing process 200, according to an embodiment of this specification. The graph database processing process 200 is executed by a graph database processing apparatus.

As shown in FIG. 2, in 210, the graph database processing apparatus obtains a current system time point of a graph database system. The graph database processing apparatus can be applied to the graph database system, to obtain the current system time point from an operating system of the graph database system. The graph database processing apparatus can also be communicatively connected to the graph database system, to initiate a system time point obtaining request to the graph database system. In response to the system time point obtaining request, the graph database system returns the current system time point of the graph database system to the graph database processing apparatus.

In 220, the graph database processing apparatus obtains a timestamp of each piece of edge data from a graph database.

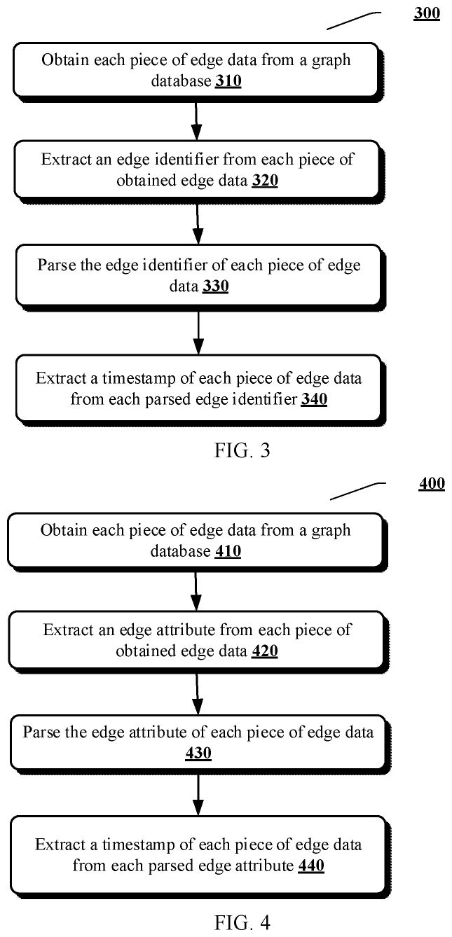

FIG. 3 is an example flowchart illustrating a timestamp obtaining process 300, according to an embodiment of this specification. In an example in FIG. 3, an edge identifier in stored edge data includes a timestamp.

As shown in FIG. 3, in 310, the graph database processing apparatus obtains each piece of edge data from the graph database. An edge data obtaining process can be obtained, in any proper data obtaining manner that matches a data structure of graph data, from a data block in which the edge data is located.

In each piece of edge data obtained from the graph database, in 320, the graph database processing apparatus extracts the edge identifier from each piece of obtained edge data. For example, in an example, an edge identifier field of the edge data has a specified length and serves as the first field of the edge data. When the edge identifier is extracted, information of a specified length can be read from a header of the edge data. Therefore, the edge identifier is extracted from the edge data.

After the edge identifier is extracted as described above, in 330, the graph database processing apparatus parses the edge identifier of each piece of edge data. In 340, the graph database processing apparatus extracts a timestamp of each piece of edge data from the parsed edge identifier of each piece of edge data.

FIG. 4 is another example flowchart illustrating a timestamp obtaining process 400, according to an embodiment of this specification. In an example in FIG. 4, the edge identifier of the stored edge data does not have a timestamp, and an edge attribute includes a timestamp attribute.

As shown in FIG. 4, in 410, the graph database processing apparatus obtains each piece of edge data from the graph database. An edge data obtaining process can be obtained, in any proper data obtaining manner that matches a data structure of graph data, from a data block in which the edge data is located.

In each piece of edge data obtained from the graph database, in 420, the graph database processing apparatus extracts the edge attribute from each piece of obtained edge data. For example, in an example, an edge identifier field of the edge data has a specified length and serves as the first field of the edge data. Therefore, information about a field after a field of a specified length of the edge data can be read, so that the edge attribute is extracted from the edge data.

In 430, the graph database processing apparatus parses the extracted edge attribute of the edge data. In 440, the graph database processing apparatus extracts the timestamp of each piece of edge data from the parsed edge attribute of each piece of edge data.

Back to FIG. 2. After the timestamp of each piece of edge data is obtained as described above, in 230, the expired edge data is determined from all the pieces of edge data based on the current system time point of the graph database system, the timestamp of each piece of edge data, and a survival time period of each piece of edge data.

For example, it is assumed that the current system time point of the graph database system is T0, the timestamp of the edge data is T1, and the survival time period of the edge data is T. If T0−T1≤T, it is determined that the edge data is unexpired edge data. If T0−T1>T, it is determined that the edge data is expired edge data.

In some embodiments, the survival time period of each piece of edge data can be entered by a user when graph database processing is performed. For example, the user can enter a corresponding survival time period for each piece of edge data. Alternatively, the user can enter a corresponding survival time period for each type of edge data.

In some embodiments, the survival time period of the edge data can be configured in a system configuration file of the graph database system. One survival time period is configured for each type of edge in the system configuration file. Optionally, the system configuration file can be updated. For example, the system configuration file can be updated in response to an application scenario or in response to a user requirement.

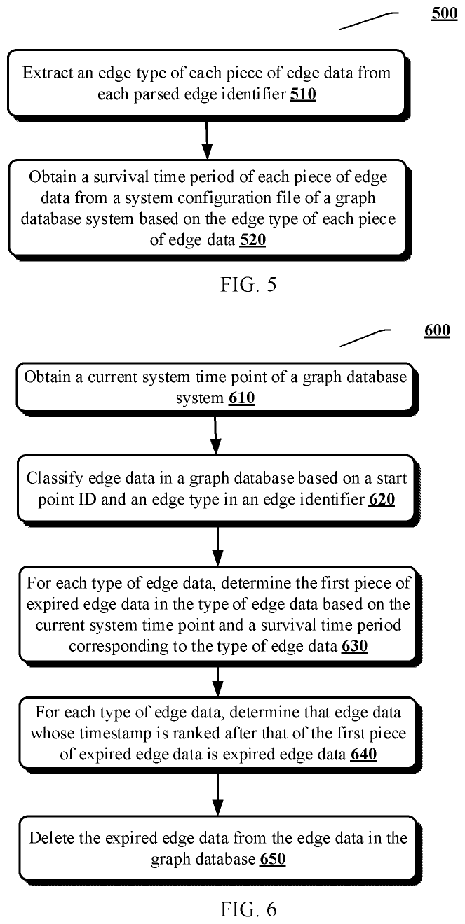

FIG. 5 is an example flowchart illustrating a survival time period obtaining process 500, according to an embodiment of this specification. In an example in FIG. 5, the survival time period of the edge data is configured in the system configuration file of the graph database system.

As shown in FIG. 5, in 510, the graph database processing apparatus extracts an edge type of each piece of edge data from the parsed edge identifier of each piece of edge data.

In 520, the graph database processing apparatus obtains the survival time period of each piece of edge data from the system configuration file of the graph database system based on the edge type of each piece of edge data.

Back to FIG. 2. After determining of the expired edge data is completed for the edge data in the graph database as described above, in 240, the determined expired edge data is deleted from the graph database in response to that the expired edge data is determined.

It should be noted that, in an example, the operation in 240 can be performed after determining of the expired edge data is completed for all the edge data of the graph database. In another example, the operation in 240 can be performed in response to that determining of the expired edge data is completed for one piece of edge data. In this case, the edge data is deleted from the graph database in response to determining that the edge data is expired edge data. The edge data is retained in response to determining that the edge data is not expired edge data.

FIG. 6 is another example flowchart illustrating a graph database processing method, according to an embodiment of this specification. In an example in FIG. 6, graph data is stored in a graph database based on a data structure shown in FIG. 1.

As shown in FIG. 6, in 610, a current system time point of a graph database system is obtained. For an obtaining process of the current system time point in 610, references can be made to the operation described in 210 in FIG. 2.

In 620, edge data in the graph database is classified based on a start point ID and an edge type in an edge identifier. All edge data in each obtained edge data type has the same start point ID and the same edge type. In an example, a classification process of the edge data can be implemented based on a dichotomy. For example, in an example, the edge data is sorted in descending order based on the start point ID and the edge type, and is sequentially stored in the graph database. During edge data classification, the first piece of edge data is read, and then an edge identifier in the first piece of edge data is obtained and parsed, to obtain the start point ID and the edge type. Then, edge data (second edge data) located in the middle in the edge data is found based on the dichotomy, and an edge identifier in the edge data is obtained and parsed, to obtain a start point ID and an edge type of the edge data. If the obtained start point ID and the obtained edge type are completely consistent with the start point ID and the edge type of the first piece of edge data, the second edge data and the first piece of edge data are the same classification data, and then intermediate edge data between the second edge data and the last piece of edge data are obtained to determine a classification boundary again. If the obtained start point ID and the obtained edge type are not completely consistent with the start point ID and the edge type of the first piece of edge data, the second edge data and the first piece of edge data are not the same classification data, and then intermediate edge data between the first piece of edge data and the second edge data are obtained to determine a classification boundary again. Edge identifier parsing is performed on the obtained intermediate edge data, the start point ID and the edge type that are parsed out are compared with the start point ID and the edge type of the first piece of edge data, and next intermediate edge data is obtained based on a comparison result, until a boundary (first-type edge data) of an edge data type to which the first piece of edge data belongs is determined. After the first-type edge data is found (that is, a boundary of the first-type edge data is determined), second-type edge data (a boundary of the second-type edge data) is determined in the above-mentioned manner starting from edge data of the first-type edge data. This loop is performed, until all edge data in the graph data is classified.

After classification is completed as described above, in 630, for each type of edge data, the first piece of expired edge data in the type of edge data is determined based on the current system time point and a survival time period corresponding to the edge type. In an example, the edge data is sorted in descending order based on the timestamp, and is sequentially stored in the graph database. When the first piece of expired edge data is determined, edge data (first intermediate edge data) located in the middle in the type of edge data is read, an edge identifier is extracted from the read edge data and parsed, a timestamp is extracted from the parsed edge identifier, and whether the first intermediate edge data is expired edge data is determined based on the current system time point, the survival time period corresponding to the edge type, and the extracted timestamp. If it is determined that the first intermediate edge data is expired edge data, intermediate edge data (the second intermediate edge data) between the first piece of edge data and the first intermediate edge data in the type of edge data is read again. If it is determined that the first intermediate edge data is unexpired edge data, intermediate edge data (the second intermediate edge data) between the first intermediate edge data and the last piece of edge data in the type of edge data is read again. Then, whether the second intermediate edge data is expired edge data is determined in the above-mentioned manner, and this loop is performed, until the first piece of expired edge data in the type of edge data is determined.

In 640, for each type of edge data, it is determined that all edge data whose timestamp is ranked after that of the first piece of expired edge data in the type of edge data is expired edge data. For example, if the edge data is sequentially stored in descending order of timestamps, all edge data ranked after the first piece of expired edge data is determined as expired edge data. If the edge data is sequentially stored in ascending order of timestamps, all edge data ranked before the first piece of expired edge data is determined as expired edge data.

Optionally, in 650, the determined expired edge data is deleted from the graph database in response to that the expired edge data is determined.

In some embodiments, after the current system time point of the graph database system is obtained, the first piece of edge data can also be obtained from the graph database. Then, an edge identifier of the first piece of edge data is parsed, and the timestamp of the edge data is determined based on the parsed edge identifier and is stored in the edge identifier or the edge attribute. If it is determined that the timestamp of the edge data is stored in the edge identifier, the expired edge data is determined in the above-mentioned expired edge data manner (that is, the manner shown in FIG. 1 and FIG. 3 or FIG. 6) corresponding to a case in which the edge identifier includes the timestamp. If it is determined that the timestamp of the edge data is stored in the edge attribute, the expired edge data is determined in the above-mentioned expired edge data manner (that is, the manner shown in FIG. 1 and FIG. 4) corresponding to a case in which the edge attribute includes the timestamp.

With reference to FIG. 1 to FIG. 6, the foregoing describes the graph database processing method according to the embodiments of this specification. According to the graph database processing method, the timestamp of the edge data is stored in the edge identifier or the edge attribute when graph data is stored, so that when the graph database is processed, the timestamp can be extracted from the edge data, and whether the edge data expires or not is determined based on the extracted timestamp and the current system time point of the graph database system, thereby quickly clearing the expired edge data in the graph database.

If the timestamp of the edge data is stored in the edge attribute, all the edge data needs to be scanned, the edge attribute is parsed to obtain the timestamp, and whether the edge data expires is determined based on the obtained timestamp. When the timestamp of the edge data is stored in the edge identifier and the edge data is sequentially stored in the graph database based on the start point ID, the edge type, the timestamp, and the endpoint ID, because the edge data is sorted based on the timestamp based on a specified start point ID and the specified edge type, edge data in the graph database can be classified based on the specified start point ID and the specified edge type, a first piece of expired edge data in each type of edge data is located based on the current system time point and the survival time period, and all edge data whose timestamp is ranked after that of the first piece of expired edge data is determined as expired edge data. There is no need to perform edge identifier parsing and expiration determining processing on the remaining edge data, thereby further reducing time required for determining the expired edge data, and improving efficiency of clearing the expired edge data in the graph database.

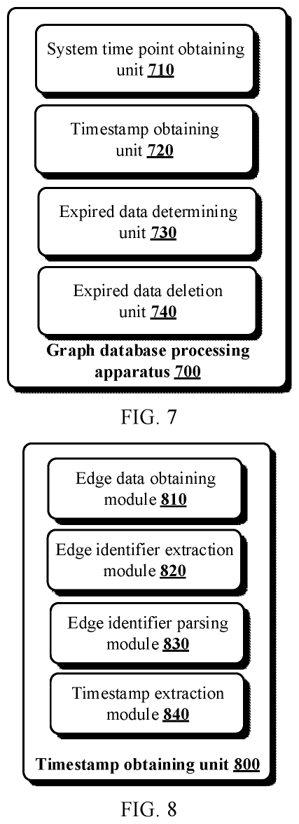

FIG. 7 is an example block diagram illustrating a graph database processing apparatus 700, according to an embodiment of this specification. As shown in FIG. 7, the graph database processing apparatus 700 includes a system time point obtaining unit 710, a timestamp obtaining unit 720, an expired data determining unit 730, and an expired data deletion unit 740.

The system time point obtaining unit 710 is configured to obtain a current system time point of a graph database system. For an operation of the system time point obtaining unit 710, references can be made to the operation described in 210 in FIG. 2.

The timestamp obtaining unit 720 is configured to obtain a timestamp of each piece of edge data from a graph database. For an operation of the timestamp obtaining unit 720, references can be made to the operations described in 220 in FIG. 2 and the operations described in FIG. 3 and FIG. 4.

The expired data determining unit 730 is configured to determine expired edge data from all the pieces of edge data based on the current system time point, the timestamp of each piece of edge data, and a survival time period of each piece of edge data. For an operation of the expired data determining unit 730, references can be made to the operations described in 220 in FIG. 2 and FIG. 5.

The expired data deletion unit 740 is configured to delete the determined expired edge data from the graph database in response to that the expired edge data is determined.

It should be noted that, in another embodiment of this specification, the graph database processing apparatus 700 can possibly not include the expired data deletion unit 740.

FIG. 8 is an example block diagram illustrating a timestamp obtaining unit 800, according to an embodiment of this specification. In an example in FIG. 8, an edge identifier of the edge data includes a timestamp. As shown in FIG. 8, the timestamp obtaining unit 800 includes an edge data obtaining module 810, an edge identifier extraction module 820, an edge identifier parsing module 830, and a timestamp extraction module 840.

The edge data obtaining module 810 is configured to obtain each piece of edge data from the graph database. For an operation of the edge data obtaining module 810, references can be made to the operation described in 310 in FIG. 3.

The edge identifier extraction module 820 is configured to extract the edge identifier from each piece of obtained edge data. For an operation of the edge identifier extraction module 820, references can be made to the operation described in 320 in FIG. 3.

The edge identifier parsing module 830 is configured to parse the edge identifier of each piece of edge data. For an operation of the edge identifier parsing module 830, references can be made to the operation described in 330 in FIG. 3.

The timestamp extraction module 840 is configured to extract the timestamp of each piece of edge data from the parsed edge identifier of each piece of edge data. For an operation of the timestamp extraction module 840, references can be made to the operation described in 340 in FIG. 3.

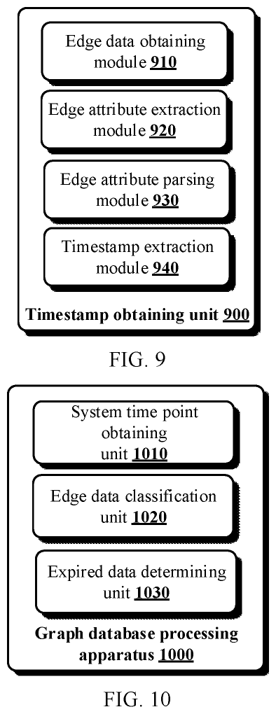

FIG. 9 is another example block diagram illustrating a timestamp obtaining unit 900, according to an embodiment of this specification. In an example in FIG. 9, an edge attribute includes a timestamp attribute. As shown in FIG. 9, the timestamp obtaining unit 900 includes an edge data obtaining module 910, an edge attribute extraction module 920, an edge attribute parsing module 930, and a timestamp extraction module 940.

The edge data obtaining module 910 is configured to obtain each piece of edge data from the graph database. For an operation of the edge data obtaining module 910, references can be made to the operation described in 410 in FIG. 4.

The edge attribute extraction module 920 is configured to extract the edge attribute from each piece of obtained edge data. For an operation of the edge attribute extraction module 920, references can be made to the operation described in 420 in FIG. 4.

The edge attribute parsing module 930 is configured to parse the extracted edge attribute of each piece of edge data. For an operation of the edge attribute parsing module 930, references can be made to the operation described in 430 in FIG. 4.

The timestamp extraction module 940 is configured to extract the timestamp of each piece of edge data from the parsed edge attribute of each piece of edge data. For an operation of the timestamp extraction module 940, references can be made to the operation described in 440 in FIG. 4.

In addition, optionally, in an example, the graph database processing apparatus 700 can further include a survival time period obtaining unit (not shown). The survival time period obtaining unit is configured to obtain a survival time period of each piece of edge data entered by a user.

In addition, optionally, in an example, the edge identifier can further include an edge type. Correspondingly, the graph database processing apparatus 700 can further include an edge type extraction unit and a survival time period obtaining unit. The edge type extraction unit is configured to extract the edge type of each piece of edge data from a parsed edge identifier of each piece of edge data; and the survival time period obtaining unit is configured to obtain the survival time period of each piece of edge data from a system configuration file of the graph database system based on the edge type of each piece of edge data.

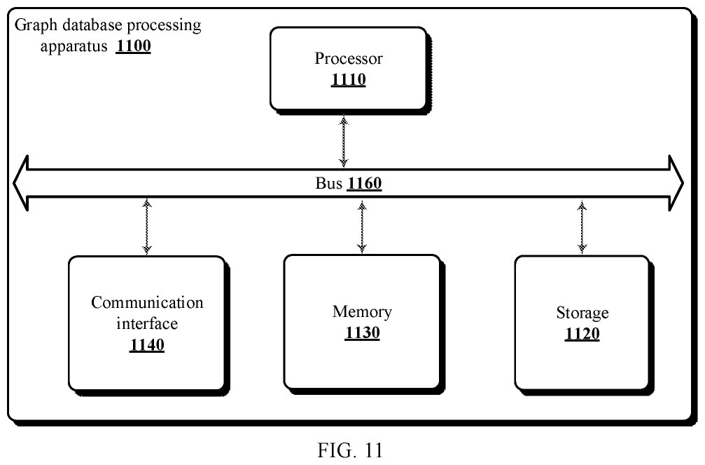

FIG. 10 is another example block diagram illustrating a graph database processing apparatus 1000, according to an embodiment of this specification. In an example in FIG. 10, an edge identifier of edge data includes a start point ID, an edge type, a timestamp, and an endpoint ID, and the edge data is sequentially sorted based on the start point ID, the edge type, the timestamp, and the endpoint ID, and then sequentially stored in the graph database. As shown in FIG. 10, the graph database processing apparatus 1000 includes a system time point obtaining unit 1010, an edge data classification unit 1020, and an expired data determining unit 1030.

The system time point obtaining unit 1010 is configured to obtain a current system time point of a graph database system. For an operation of the system time point obtaining unit 1010, references can be made to the operation described in 610 in FIG. 6.

The edge data classification unit 1020 is configured to classify the edge data in the graph database based on the start point ID and the edge type in the edge identifier. For an operation of the edge data classification unit 1020, references can be made to the operation described in 620 in FIG. 6.

The expired data determining unit 1030 is configured to: for each type of edge data, determine the first piece of expired edge data in the type of edge data based on the current system time point and a survival time period corresponding to the edge type, and determine that all edge data whose timestamp is ranked after that of the first piece of expired edge data in the type of edge data is expired edge data. For an operation of the expired data determining unit 1030, references can be made to the operations described in 630 and 640 in FIG. 6.

With reference to FIG. 1 to FIG. 10, the foregoing describes the graph database processing method and the graph database processing apparatus according to the embodiments of this specification. The graph database processing apparatus can be implemented by using hardware, or can be implemented by using software or a combination of hardware and software.

FIG. 11 is a schematic diagram illustrating a graph database processing apparatus 1100 implemented based on a computer system, according to an embodiment of this specification. As shown in FIG. 11, the graph database processing apparatus 1100 can include at least one processor 1110, a storage (for example, a non-volatile memory) 1120, a memory 1130, and a communication interface 1140, and the at least one processor 1110, the storage 1120, the memory 1130, and the communication interface 1140 are connected together by using a bus 1160. The at least one processor 1110 executes at least one computer-readable instruction (namely, the foregoing element implemented in a software form) stored or encoded in the storage.

In an embodiment, computer-executable instructions are stored in the storage, and when the computer-executable instructions are executed, the at least one processor 1110 is enabled to perform the following operations: obtaining a current system time point of a graph database system; obtaining a timestamp of each piece of edge data from a graph database; and determining expired edge data from all the pieces of edge data based on the current system time point of the graph database system, the timestamp of each piece of edge data, and a survival time period of each piece of edge data.

In another embodiment, computer-executable instructions are stored in the storage, and when the computer-executable instructions are executed, the at least one processor 1110 is enabled to perform the following operations: obtaining a current system time point of a graph database system; classifying edge data in a graph database based on a start point ID and an edge type in an edge identifier; and for each type of edge data, determining the first piece of expired edge data in the type of edge data based on the current system time point and a survival time period corresponding to the edge type, and determining that all edge data whose timestamp is ranked after that of the first piece of expired edge data in the type of edge data is expired edge data.

It should be understood that, when the computer-executable instructions stored in the storage are executed, the at least one processor 1110 is enabled to perform the above-mentioned operations and functions described with reference to FIG. 1 to FIG. 10 in the embodiments of this specification.

According to an embodiment, a program product such as a machine-readable medium (for example, a non-temporary machine-readable medium) is provided. The machine-readable medium can have instructions (that is, the above-mentioned elements implemented in a software form). When the instructions are executed by a machine, the machine is enabled to perform the above-mentioned operations and functions described with reference to FIG. 1 to FIG. 10 in the embodiments of this specification. Specifically, a system or an apparatus provided with a readable storage medium can be provided, and software program code for implementing the functions in any of the above-mentioned embodiments is stored in the readable storage medium, so that a computer or a processor of the system or the apparatus reads and executes instructions stored in the readable storage medium.

In this case, the program code read from the readable medium can implement the function in any one of the foregoing embodiments. Therefore, the machine-readable code and the readable storage medium that stores the machine-readable code form a part of this specification.

Embodiments of the readable storage medium include a floppy disk, a hard disk, a magneto-optical disc, an optical disc (for example, a CD-ROM, a CD-R, a CD-RW, a DVD-ROM, a DVD-RAM, a DVD-RW, and a DVD-RW), a magnetic tape, a non-volatile storage card, and a ROM. Alternatively, program code can be downloaded from a server computer or cloud through a communication network.

According to an embodiment, a computer program product is provided. The computer program product includes a computer program, and when the computer program is executed by a processor, the processor is enabled to perform the above-mentioned operations and functions described with reference to FIG. 1 to FIG. 10 in the embodiments of this specification.

A person skilled in the art should understand that various variations and modifications can be made to the embodiments disclosed above without departing from the essence of the present invention. Therefore, the protection scope of this specification shall be limited by the appended claims.

It should be noted that not all the steps and units in the foregoing processes and system structural diagrams are required, and some steps or units can be ignored based on an actual requirement. An execution sequence of the steps is not fixed, and can be determined based on a requirement. The apparatus structure described in the foregoing embodiments can be a physical structure, or can be a logical structure, that is, some units may be implemented by a same physical entity, or some units may be implemented by a plurality of physical entities, or can be jointly implemented by some components in a plurality of independent devices.

In the above-mentioned embodiments, the hardware unit or module can be implemented in a mechanical manner or an electrical manner. For example, a hardware unit, a module, or a processor can include a dedicated permanent circuit or logic (for example, a dedicated processor, an FPGA, or an ASIC) to complete a corresponding operation. The hardware unit or the processor can further include programmable logic or circuits (for example, a general-purpose processor or another programmable processor), and can be temporarily disposed by the software, to complete a corresponding operation. A specific implementation (a mechanical manner, a dedicated permanent circuit, or a temporarily disposed circuit) can be determined in considerations of costs and time.

The specific implementations described above with reference to the accompanying drawings describe example embodiments, but do not represent all embodiments that can be implemented or fall within the protection scope of the claims. The term “example” used throughout this specification means “used as an example, an instance, or an illustration” and does not mean “preferred” or “advantageous” over other embodiments. For the purpose of providing an understanding of the described technology, the specific implementations include specific details. However, these techniques can be implemented without these specific details. In some instances, well-known structures and apparatuses are shown in block diagram forms, to avoid difficulty in understanding the concept in the described embodiments.

The above-mentioned descriptions of content of this disclosure are provided to enable any person of ordinary skill in the art to implement or use the content of this disclosure. It is obvious to a person of ordinary skill in the art that various modifications can be made to the content of this disclosure. In addition, the general principle defined in this specification can be applied to another variant without departing from the protection scope of the content of this disclosure. Therefore, the content of this disclosure is not limited to the examples and designs described in this specification, but is consistent with the widest range of principles and novelty features that conform to this specification.

1. A graph database processing method, comprising:
obtaining a current system time point of a graph database system;
obtaining a timestamp of each piece of edge data from a graph database; and
determining expired edge data from each piece of edge data based on the current system time point, the timestamp of each piece of edge data, and a survival time period of each piece of edge data.

2. The graph database processing method according to claim 1, further comprising:
deleting the determined expired edge data from the graph database.

3. The graph database processing method according to claim 1, wherein an edge identifier of the edge data comprises a timestamp, and the obtaining a timestamp of each piece of edge data from a graph database comprises:
obtaining each piece of edge data from the graph database;
extracting the edge identifier from each piece of obtained edge data;
parsing the edge identifier of each piece of edge data; and
extracting the timestamp of each piece of edge data from the parsed edge identifier of each piece of edge data.

4. The graph database processing method according to claim 1, wherein an edge attribute of the edge data comprises a timestamp attribute, and the obtaining a timestamp of each piece of edge data from a graph database comprises:
obtaining each piece of edge data from the graph database;
extracting the edge attribute from each piece of obtained edge data;
parsing the extracted edge attribute of each piece of edge data; and
extracting the timestamp of each piece of edge data from the parsed edge attribute of each piece of edge data.

5. The graph database processing method according to claim 1, wherein the survival time period of each piece of edge data comprises a survival time period of each piece of edge data entered by a user.

6. The graph database processing method according to claim 1, wherein an edge identifier of the edge data comprises an edge type, and the graph database processing method further comprises:
extracting the edge type of each piece of edge data from a parsed edge identifier of each piece of edge data; and
obtaining the survival time period of each piece of edge data from a system configuration file of the graph database system based on the edge type of each piece of edge data.

7. A graph database processing method, wherein an edge identifier of edge data in a graph database comprises a start point ID, an edge type, a timestamp, and an endpoint ID, the edge data is sorted based on the start point ID, the edge type, the timestamp, and the endpoint ID, and then sequentially stored in the graph database, and the graph database processing method comprises:
obtaining a current system time point of a graph database system;
classifying the edge data in the graph database based on the start point ID and the edge type in the edge identifier; and
for each type of edge data, determining the first piece of expired edge data in the type of edge data based on the current system time point and a survival time period corresponding to the edge type, and determining that all edge data whose timestamp is ranked after that of the first piece of expired edge data in the type of edge data is expired edge data.

8. The graph database processing method according to claim 7, wherein a classification process of the edge data and/or a determining process of the first piece of expired edge data are implemented based on a dichotomy.

9. (canceled)

10. (canceled)

11. (canceled)

12. (canceled)

13. (canceled)

14. (canceled)

15. (canceled)

16. A graph database processing apparatus comprising a memory and a processor, wherein the memory stores executable instructions that, in response to execution by the processor, cause the processor to:
obtain a current system time point of a graph database system;
obtain a timestamp of each piece of edge data from a graph database; and
determine expired edge data from each piece of edge data based on the current system time point, the timestamp of each piece of edge data, and a survival time period of each piece of edge data.

17. A non-transitory computer-readable storage medium comprising instructions stored therein that, when executed by a processor of a computing device, cause the processor to:
obtain a current system time point of a graph database system;
obtain a timestamp of each piece of edge data from a graph database; and
determine expired edge data from each piece of edge data based on the current system time point, the timestamp of each piece of edge data, and a survival time period of each piece of edge data.

18. (canceled)
